(19) United States
(12) Patent Application Publication
(10) Pub. No.: US 2012/0227671 A1
(43) Pub. Date: Sep. 13, 2012

(54) Texas HayNet

(76) Inventor: Leslie W. Davis, Kingsland, TX (US)

(21) Appl. No.: 12/932,763

(22) Filed: Mar. 7, 2011

(51) Int. Cl. A01K 5/00

(52) U.S. Cl. 119/65

(57) ABSTRACT

The Texas HayNet is a durable netting configured to fit over a round bale of hay that is up to six and a half foot tall. The netting is made of a proprietary blend of hemp and plastic threads to provide durability with the net openings calibrated to hold the hay intact and allow livestock to eat at a measured pace. The net is secured to the bale by two pairs of drawstrings on the circumference of the netting. The net is sufficiently flexible as to maintain the shape of the bale and the availability of feed as livestock consume the bale.

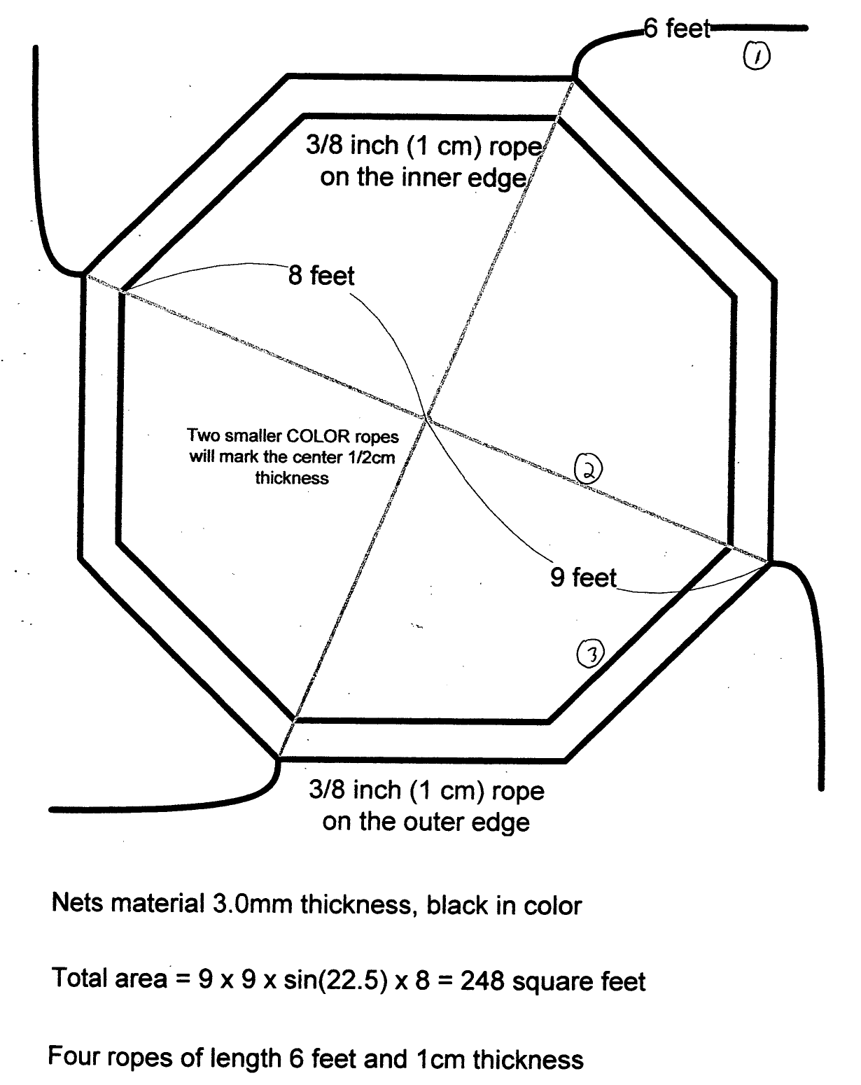

### TITLE OF INVENTION

Texas HayNet is a system of retaining the shape of a standard roll of hay to limit waste and boost the nutritional value of the hay to livestock eating the hay. It does this by covering the roll of hay of up to 7′ in heights with a durable and pliable netting that maintains the shape of the roll of hay, resists the livestocks' attempts to eat the hay too rapidly, and minimizes the waste of hay on the ground under the livestocks' hooves. The netting is made of 1.75 inch squares and is held in place by a system of woven in ropes with which to tighten the netting around the roll of hay.

### BACKGROUND OF THE INVENTION

The Texas HayNet was created in response to research that slowing the process of eating hay by horses was beneficial in preventing disease in horses such as laminitis. Research specifically pointed out that if horses were forced to eat through 2″ holes, they would eat more slowly and limit the warming effects of rapid ingestion of proteins that would provide a favorable environment for toxins to reside in the hooves of the horse. The challenge of developing a method of slowing ingestion was to find an inexpensive material that would provide the durability to resist the impact of a horse bit delivers pressure in excess of 2,000 pounds per inch while being sufficiently soft and pliable as to not discourage the horse from eating.

As the HayNet was developed, an associated objective was developed; to provide a way to contain the hay that was easy to apply to the roll, would change with the reducing volume of the roll as the hay was consumed, and not impacted by horses stepping, rolling, sleeping, or defecating on the net.

Several materials were tested. By the process of experimentation and elimination, a design of a basic fishnet made of custom materials met the basic criteria for the material. To the basic design, ropes were added to draw the HayNet around the roll of hay for easy application as well as colored ropes woven into the design to assist in centering the Texas HayNet over the roll of hay.

### BRIEF SUMMARY OF THE INVENTION

The Texas HayNet covers the roll of hay inclusively, forcing horse eating the hay to eat through the netting. The material is sufficiently durable to usually last, in field tests, in excess of a year. The exclusions to this durability is if the livestock have horns (which is why it is designed specifically for horses) and when the horses have halters or other tack that has metal points that can rip the material. The material is sufficiently flexible that while some horses attack the netting as they attempt to eat aggressively, they usually slow down to a more desired pace of eating and never give up and turn away from the hay. The HayNet has a unique series of ropes designed to easily attach it to the hay.

### BRIEF DESCRIPTION OF THE SEVERAL VIEWS OF THE DRAWING

There is one drawing which depicts the HayNet as it is laid out flat.

### DETAILED DESCRIPTION OF THE INVENTION

The drawing is based on an octagon design with a nine foot radius. The complete area of net is made of 3 mm woven polypropylene strands, tied together at spaces providing 1.75 inch holes in the netting. The netting is reinforced by two 1 cm ropes (3) woven into the netting, one at the perimeter of the net and other one foot in from the perimeter. The outer rope at four locations on the perimeter (1) is extended six additional feet to serve as drawstrings to secure the net to the roll of hay. There are two 0.5 cm red ropes (2) into the netting that cross perpendicular at the center of the net so the user can center the net over the roll of hay.

The HayNet starts with basic netting made by manufacturers who are experienced in making fishnets. The material that the net is made of is a blend of polypropylene fibers designed to resist the pressure of a horse's bite but sufficiently soft and flexible as to not irritate the nose of the horse. The netting consists of a square design, with hand-tied knots every 1.75″

The basic design could be eight, six, or four sided. The HayNet is applied to the roll of hay by draping the netting over the roll of hay, centering the net with the drawstrings extended out from the roll of hay. Once the net covers the roll, each pair of opposing drawstrings are tied to each other in such a manner that they can be tightened, thereby securing the net to the roll.

### Other Methods of Binding Hay

The netting that many rolls are bound in when they are harvested have been used as supporting the binding of hay to keep its shape, but this netting either gets trampled into the ground or is cut of when the farmer places the hay in the field. In either case, it does not slow the eating process and it does not limit waste. Unless it is picked up after livestock finish eating the hay, the netting gets caught in tilling equipment.

Metal circle U.S. Pat. No. 6,789,504—limits the effect of hooves, and is recommended for use with the Texas HayNet

Small hay nets capable of holding in place a square bale of hay (typically less than 3′×2′×2′)—U.S. Pat. No. 5,098,754

There are more complex methods of holding a roll, such as U.S. Pat. No. 812,252.

What is claimed is:

1. A netting that has four to eight sides comprising of
1. netting with holes in the netting of 1.75 to 2 inches
2. made of durable fibers
3. secured to the role of hay by 1 cm ropes

2. The netting as set forth in claim 1 wherein the netting is made up of a proprietary blend of polypropylene fibers that are resistant to the pressure of the bites of livestock and pliant enough to not discourage the livestocks' eating process.

3. The netting as set forth in claim 1 which is secured by a system of four ropes that are
1. woven into the netting to the roll of hay to maintain their position as the netting is taken on and off
2. positioned to be easily accessible such that
3. they can easily be tied together to secure the net to the roll of hay

4. The netting as set forth in claim 1 where two colored ropes are woven into the netting to allow the user to center the net

5. A material that is porous that conforms to the shape of the roll of hay as the roll is consumed.

6. Said material in claim 2 that preserves the shape of the hay and limits feed waste

7. Said material in claim 2 that slows down the process livestock use to consume hay, thereby providing nutrition to the livestock without the danger of too rapid consumption.

8. A mechanism that acts passively to maintain the shape of the hay to minimize waste
